(19) United States
(12) Patent Application Publication
(10) Pub. No.: US 2010/0299856 A1
(43) Pub. Date: Dec. 2, 2010

(54) TOOTHBRUSH ATTACHMENT AND METHOD FOR THE PRODUCTION THEREOF

(76) Inventors: Rudolf Majthan, Eschborn (DE); Hans-Herbert Fuchs, Hofheim (DE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/599,745

(22) PCT Filed: May 15, 2008
(86) PCT No.: PCT/EP2008/003901

§ 371 Date: Nov. 11, 2009

(30) Foreign Application Priority Data
May 15, 2007 (DE) 10 2007 022 827.0

(51) Int. Cl. A46B 13/00; B23P 17/04

(52) U.S. Cl. 15/22.1; 29/428

(57) ABSTRACT

The present invention relates to a toothbrush attachment for an electric toothbrush, having a preferably tube-shaped body part on which an electronic module, such as a transponder, is mounted. The invention further relates to a method for producing such a toothbrush attachment and to a toothbrush having such a toothbrush attachment. According to the invention, the at least one electronic component is welded into the toothbrush attachment. According to the invention, the electronic component is encapsulated in an intermediate space between two body parts of the toothbrush attachment and is closed by at least one weld seam bonding the two body parts to each other. This ensures comprehensive protection of the electronic component by the body parts covering it.

The present invention relates to a toothbrush attachment for an electric toothbrush, having a preferably tube-shaped body part on which an electronic module, for example a transponder module is fastened. The present invention further relates to a method for manufacturing such a toothbrush attachment, as well as to a toothbrush having such an attachment.

It is known to provide toothbrush attachment parts with electronic modules, for example in the form of a transponder or other communication elements that are capable of communicating inductively, capacitively, by radio, or in some other way, in particular wirelessly, with a control unit on the toothbrush handle. For example, the electronic module can provide an identifier of the toothbrush attachment that is requested by the control unit of the toothbrush handle when the toothbrush attachment is placed on the handle or is brought into its vicinity. Because such electronic modules are generally sensitive, in particular transponder modules must be protected from moisture, the fastening of such electronic or communication modules to the toothbrush handle is not without difficulties, because the handle is held under running water and is also exposed to other substances such as toothpaste and the like.

On this basis, the present invention is based on the object of creating an improved toothbrush and in particular an improved toothbrush attachment of the type named, as well as an improved method for its manufacture, which avoid the disadvantages of the prior art and further develop the prior art in an advantageous manner Preferably, a long-lasting protection that is easy to manufacture is to be created for the electronic module without impairing its function. Moreover, an extremely low failure rate of the protection or of the insulation against moisture of the electronic module can optionally be ensured.

According to the present invention, this object is achieved by a toothbrush attachment according to claim 1, a toothbrush according to claim 16, and a method for manufacture of such a toothbrush attachment according to claim 17. Preferred embodiments of the present invention are the subject matter of the dependent claims.

Thus, it is proposed to weld an electronic module onto the toothbrush attachment. According to the invention, the electronic module is encapsulated in an intermediate space between two body parts of the toothbrush attachment, wherein the said space is sealed by at least one weld seam that materially bonds the two body parts to one another. Surprisingly, given suitable realization of the welding process, the electronic module is not damaged as a result of the effects of heat or the like during the welding of the body parts surrounding it. In this process, the body parts that cover it ensure a comprehensive protection of the electronic module.

In principle, the electronic module can be fastened at various locations on the body of the toothbrush attachment. According to a preferred embodiment of the invention, the electronic module is enclosed between a brush tube of the attachment and a profile ring fastened thereto. Said profile ring can be placed on one end of the brush tube or can be suspended over and onto the tube. Advantageously, however, said profile ring is inserted into said brush tube with a plug-in segment; wherein, in this case, the electronic module is advantageously arranged between the segment of the profile ring inserted into the brush tube and the brush tube segment surrounding this pushed-in segment.

In an advantageous development of the invention, the at least one weld seam is placed at a location that is inaccessible and/or not visible from the outside, so that on the one hand the weld seam itself is protected from external influences and on the other hand the external appearance of the toothbrush attachment is not impaired. In particular, the at least one weld seam can be formed as a hidden blind seam that is situated between the body parts and is covered by these two body parts at least on all visible sides. Advantageously, a completely internal weld seam can be provided that is covered on all sides by the body parts bonded by the weld seam.

In principle, this weld seam can be produced in various ways. According to an advantageous embodiment of the invention, the two body parts between which the electronic module is situated are bonded to one another by friction welding. For this purpose, the two body parts can sit on top of one another via defined fitting surfaces, for example in the form of a projection or the like, so that a defined weld seam results when there is a corresponding movement of the two parts relative to one another. Frictional welding offers a useful approach in particular given a rotationally symmetrical construction of the two body parts, which can be the case in the above-mentioned arrangement of the electronic module between a brush tube segment and a profile ring connected thereto. Given a rotationally symmetrical construction of the body parts, these parts can be bonded to one another by rotational welding.

Alternatively, or in addition, the two body parts between which the electronic module sits can advantageously be materially bonded to one another by laser welding. Laser welding is especially advantageous if the body parts to be welded are not shaped in rotationally symmetrical form, e.g. are oval, rectangular, rectangular with radii, etc., or if non-rotationally-symmetrical weld seam configurations are desired. In this process, a low application of energy can be used that does not entail or only slightly entails heat stress for the electronic component even if the weld seam is placed in direct proximity to the electronic module. In particular, welding can take place here using the laser beam welding method in order to produce an internal weld seam that is not visible from the outside. In this instance, the beam can pass through the outer body part, so that the material is melted only in a deeper-lying layer, in particular the material at the join surface of the two body parts.

In a development of the invention it can be provided that the two body parts to be welded, and/or various layers of a body part, are formed differently with regard to their absorption of laser light in order to facilitate or enable the laser beam welding of the two body parts. In a development of the invention, in particular an external body part can be comprised of, at least in the area intended for the welding, a material that is a poor absorber of laser light, preferably transparent, wherein this material can nonetheless advantageously appear colored or white to the human eye. Various materials may be suitable here, depending on the laser used for the laser beam welding, wherein advantageously, a suitable plastic is selected for the respective laser light.

In a development of the invention, on the other hand it is advantageously provided that an internal body part is, at least in the area provided for the welding, absorbent with regard to laser light, or has a coating that is absorbent to laser light. Correspondingly, during the laser beam welding the laser beam can penetrate the outer material, which is transparent to laser light, without melting it, while the laser beam is then absorbed by the internal body part or a coating applied thereon, so that heat is correspondingly produced and the material is melted for the welding. The laser light absorption effect can be achieved by a suitable pigmentation of the material used, wherein plastic is advantageously selected here.

In principle, various seam configurations and various arrangements of the electronic module between the body parts are possible with regard to the welding of the electronic module. In an advantageous development of the invention, the electronic module is welded between two body parts that plug in to one another, wherein the two body parts are bonded by at least one circular closed weld seam that seals an circular intermediate space in which the electronic module is positioned. In particular, two circular weld seams situated apart from one another may be put into place, between which the electronic module that is to be protected is arranged. In this case, the two weld seams can in principle be provided at different positions, depending on the contouring of the body parts that sit on top of one another. According to an advantageous embodiment of the invention, the two body parts are welded to one another at their jacket surfaces. The two circular weld seams extend along the jacket surfaces on top of one another of both body parts, and bond an inner jacket surface of the one body part to an outer jacket surface of the other body part.

Given two weld seams both of which are circular and that are situated apart from one another, it can be advantageous for the two circular weld seams to have approximately the same diameter. At the segments provided for the welding, in particular in the case of rotational welding, this results in approximately equal frictional or relative speeds between the body parts that are to be welded, and, correspondingly, approximately equal quantities of heat.

The two body parts between which the electronic module sits can be welded to one another in immediate proximity to the electronic module; i.e., the corresponding weld seams can run directly along the electronic module. In this way, larger intermediate spaces surrounding the electronic module are avoided; i.e., the electronic module is welded with minimal space requirement.

To the extent that it is a high priority for the electronic module to be protected from moisture, the weld seam between the body parts is advantageously made impervious to moisture. In order to further protect the electronic module, the weld seam can also be formed so as to be impervious to gas.

Advantageously, the welded connection between the body parts enclosing the electronic module is not the only bond between these two parts. In a development of the invention, both body parts can additionally be bonded to one another by a preferably positive bonding. On the one hand, this simplifies the welding of the two components, because the positive connection already holds the two body parts in the desired position to one another when the welding is carried out. On the other hand, the welding is relieved of excess mechanical forces. Here the positive connection between the two body parts can be formed in various ways; for example, both parts can be screwed together. In a preferred embodiment of the invention, a snap-on connection can be provided between the two body parts. Correspondingly, the two body parts with the electronic module situated between them need only be snapped together so that they can subsequently be welded without difficulty in order to achieve the desired tight encapsulation of the electronic module.

An extremely low failure rate of the protection or moisture insulation of the electronic module results from the fact that the electronic module is additionally cast in a casting resin, wherein the electronic module is cast on a body part of the attachment; i.e., before joining, the electronic module is cast in, for example, a casting resin that is to be hardened by UV radiation in order to surround the electronic module with a resin casing. Optionally, a pre-treatment with plasma before the application of the material may be necessary, wherein the resin is hardened by UV radiation.

Another solution for an extremely low failure rate of the protection or moisture insulation of the electronic module results in that the electronic module, together with the body part, is additionally encased beforehand by means of a shrinkable tube.

Due to the combination of several methods, a failure of the electronic module can take place only if, for example, an incorrectly cast electronic module occurs together with a poorly welded module, which is extremely rare, so that an extremely low failure rate is ensured.

Optionally, the welding methods can be combined with the casting resin and shrinkable tubing methods, such as for example casting and welding, shrinkable tube casing with welding, or also only the welding method or the casting resin or the shrinkable tube method may be provided.

These and additional features of the invention, which can form the subject matter of the invention independent of their combination in the claims either alone or in some other combination or sub-combination, result both from the claims and also from the following description and the associated illustrations, from which a preferred exemplary embodiment is described.

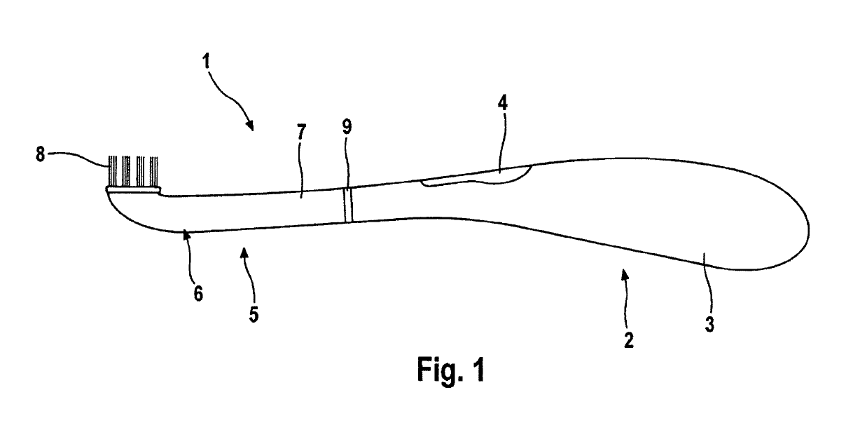

FIG. 1 shows a schematic side view of an electric toothbrush having a handle and a brush attachment placed thereon, and

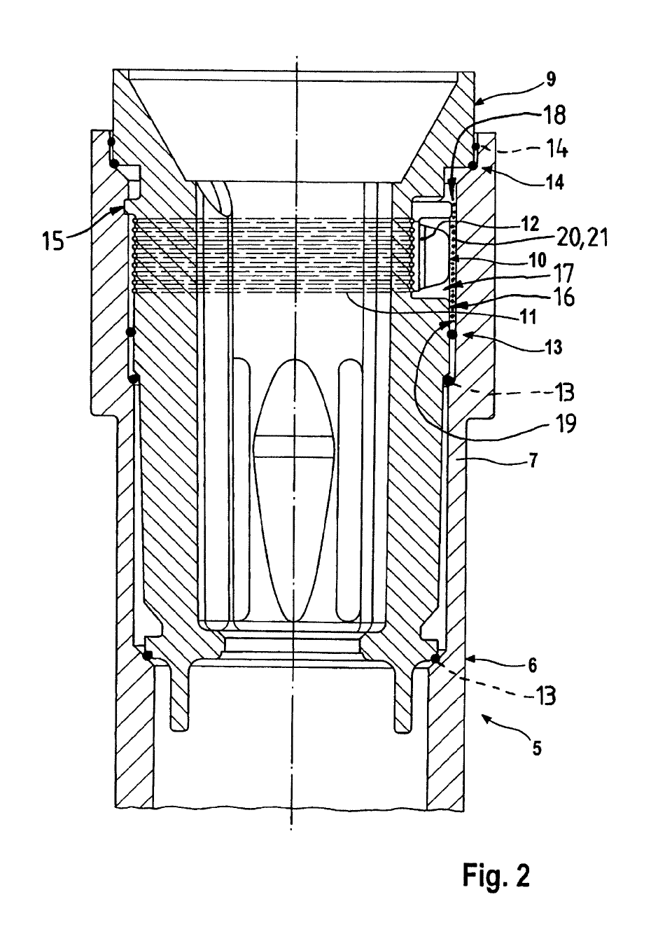

FIG. 2 shows a segment of a longitudinal section through the brush tube and the profile ring placed thereon of the brush attachment of the electric toothbrush from FIG. 1.

The toothbrush 1 shown in FIG. 1 comprises a handle 2 in which housing 3 a drive motor, a control device having at least one on-and-off switch 4, and an energy storage device, for example in the form of a battery, are provided in a known method.

According to FIG. 1, a toothbrush attachment 5 in the form of a brush attachment 6 is placed on the named handle 2, which attachment comprises a brush tube 7 that comprises a brush field 8 that can be, for example, driven rotationally and that is capable of being connected to the handle 2. A known transformer extends inside the brush tube 7 that couples the brush field 8 to the drive motor in handle 2.

As FIG. 2 shows, a profile ring 9 sits on the end of brush tube 7 of the handle 2 that at one end extends a certain distance beyond the brush tube 7 and is placed into the brush tube 7; cf. FIG. 2. In this process, the brush tube 7 as well as the named profile ring 9 form two body parts between which an electronic module 10 is arranged that, in the illustrated embodiment, is a transponder module having a preferably coaxially arranged coil 11 and a chip or circuit board 12 connected thereto.

As FIG. 2 shows in more detail, the electronic module 10 is arranged on a section of the profile ring 9 that is situated apart from the end of the brush tube 7 or the profile ring 9, wherein, in the illustrated embodiment shown here, said ring has a recess 17 on its outer jacket surface 16 into which the circuit board 12 is placed that is connected to the coil 11 that extends around the profile ring 9. The recess 17 can optionally be arranged so as to be axially offset, in order, for example, to optionally achieve an optimized automatic contact between the coil 11 and the circuit board 12.

The profile ring 9 that comprises the electronic module 10 is first placed onto or into the brush tube 7 and is fastened to the brush tube 7 with a positive fit by means of snap-on connection 15. As FIG. 2 shows, the electronic module 10 sits in the intermediate space 18 between the jacket surfaces of the brush tube 7 and the profile ring 9.

In order to encapsulate the electronic module 10 so as to be impervious to moisture and/or gas, the brush tube 7 and profile ring 9 are welded to one another using two circular weld seams 13 and 14 that are situated axially apart from one another and that enclose the electronic module 10 between them. According to FIG. 2, the two weld seams 13 and 14 are provided directly above or directly below the electronic module 10.

The weld seams 13 (shown with dotted lines) and 14 can advantageously be produced by rotational welding, i.e. rotational friction welding. For this purpose, the two body parts sit on top of one another via corresponding fitting surfaces in the area of weld seams 13 and 14 that are to be produced, so that frictional heat is produced at defined segments through corresponding rotational movement of the two parts relative to one another, the material is melted, and the welding takes place. Advantageously, both seams can be produced simultaneously in one working step through correspondingly formed step geometry of the layered components, as is shown in FIG. 2. For example, the two components can sit on top of one another via shoulders or steps only in the area of the weld seams 13 and 14 that are to be produced, in order to achieve a defined welding only at these locations.

Alternatively, the two weld seams 13 and 14 (shown with dotted lines) can also be produced during the laser welding process, in particular laser beam welding, which is suggested in particular if the brush tube 7 and profile ring 9 do not have a rotationally symmetrical shape. Advantageously, for this purpose the brush tube 7, which forms the outer casing in the illustrated embodiment, is made to be transparent with respect to the laser light used for the welding, while at the same time it appears colored or white to the human eye. On the other hand, the internal component, which is formed by the profile ring 9 in the illustrated embodiment, is equipped with absorbent properties with regard to laser light, which can be achieved for example by pigmentation or optionally the use of a suitable absorber pigment. In this way, the laser beam passes, so to speak, through the brush tube 7 from the outside and is not absorbed until it meets the internal profile ring 9 and is converted into heat, whereby the material in the area of the join surfaces or fitting surfaces between the two components is melted and the welding takes place.

Through the welding in of the electronic module 10 according to the invention, a very high degree of process security is achieved, and integration into a fully automatic assembly line is made possible. Thereby short process times enable cost-effective manufacturing or assembly. Apart from this, the weld connection of the two body parts is distinguished by a high degree of strength. At the same time, it is achieved that the profile ring 9, and thus the electronic module 10, cannot be removed. As is indicated with dotted lines, in particular a friction weld seam 13 or a laser weld seam 14 may optionally also be provided at these locations.

A schematically indicated dotted line represents a casting resin layer 20 that ensures additional protection or moisture insulation of the electronic component 10, wherein the electronic component 10 is cast with a liquid sealing component, in particular by a casting resin 20, or by being surrounded by a lacquer 20 or sealed in an immersion method, preferably by means of a wax 20.

Alternatively, the schematically indicated dotted line represents a shrinkable tube casing 21 that ensures additional protection or moisture insulation of electronic component 10. The shrinking process of shrinkable tube 21 takes place through the targeted application of heat energy.

What is claimed is:

1. A toothbrush attachment for an electric toothbrush (1), having a preferably tube-shaped body part (7) on which an electronic module (10) is arranged, for example a transponder module, characterized in that the electronic module (10) is encapsulated in an intermediate space between two body parts (7, 9), said space being sealed by at least one weld seam (13, 14) that materially bonds the two body parts (7, 9) to one another.

2. The toothbrush attachment according to the preceding claim, wherein the two body parts (7, 9) are formed by a brush tube (7) and a profile ring (9) fastened thereto.

3. The toothbrush attachment according to one of the preceding claims, wherein the at least one weld seam (13, 14) is formed as a hidden blind seam that is situated between the body parts (7, 9) and is covered by the two body parts (7, 9) at least on all sides that are visible and/or accessible from the outside, preferably being covered on all sides.

4. The toothbrush attachment according to one of the preceding claims, wherein the intermediate space is formed with a circular shape and is provided between the two body parts (7, 9) that plug in to one another, and wherein the at least one weld seam (13, 14) has a closed circular configuration.

5. The toothbrush attachment according to one of the preceding claims, wherein the at least one weld seam (13, 14) connects an inner jacket surface (19) of the one body part (7) to an outer jacket surface (16) of the other body part (9).

6. The toothbrush attachment according to one of the preceding claims, wherein the electronic module (10) is contained in a circular intermediate space (18) between the body parts (7, 9) that plug into one another, wherein the said intermediate space is sealed by two weld seams that run in circular fashion and that are situated axially apart from one another.

7. The toothbrush attachment according to one of the preceding claims, wherein an external body part (7) is formed so as to be a poor absorber of laser light, preferably transparent to laser light, at least in the area of the at least one weld seam.

8. The toothbrush attachment according to one of the preceding claims, wherein an internal body part (9) is formed so as to be absorbent to laser light at least in the area of the at least one weld seam (13, 14), and/or has a coating that is absorbent to laser light.

9. The toothbrush attachment according to one of the preceding claims, wherein the at least one weld seam (13, 14) is formed as a frictional weld seam.

10. The toothbrush attachment according to one of claims 1 through 8, wherein the at least one weld seam (13, 14) is formed as a laser weld seam.

11. The toothbrush attachment according to one of the preceding claims, wherein the intermediate space in which the electronic module (10) is contained is sealed by the at least one weld seam (13, 14) so as to be impervious to moisture and/or gas.

12. The toothbrush attachment according to one of the preceding claims, wherein the at least one weld seam (13, 14) extends directly past the electronic module (10) and/or in direct proximity to the electronic module (10).

13. The toothbrush attachment according to one of the preceding claims, wherein the two body parts (7, 9) are connected to one another by a positive connection, preferably a snap-on connection (15).

14. The toothbrush attachment according to at least claim 1, wherein the electronic module (10) is additionally encapsulated by means of a casting resin (20).

15. The toothbrush attachment according to at least claim 1, wherein the electronic module (10) along with the internal body part (9) is additionally protected, preferably against moisture, by means of a shrinkage tube (21).

16. A toothbrush having a toothbrush attachment according to one of the preceding claims.

17. A method for manufacturing a toothbrush attachment, in particular according to one of claims 1 through 13, wherein at least one electronic module (10) is arranged on a body part (7), characterized in that the electronic module (10) is positioned between two body parts (7, 9) that are joined to one another in such a way that the electronic module (10) is enclosed in an intermediate space (18) between the two body parts (7, 9), wherein the two body parts (7, 9) are welded to one another by at least one weld seam (13, 14) that seals the intermediate space (18) in which the electronic module (10) is contained.

18. The method according to the preceding claim, wherein the two body parts (7, 9) are welded to one another by laser welding.

19. The method according to the preceding claim, wherein an internally hidden weld seam (13, 14) is produced by laser beam welding.

20. The method according to claim 15, wherein the two body parts (7, 9) are frictionally welded to one another, preferably by rotational welding.

21. The method according to the preceding claim, wherein a plurality of weld seams (13, 14) are produced simultaneously by friction welding.

22. The method according to claim 17, wherein the electronic module (10) is additionally sealed in an earlier method step.

23. The method according to claim 22, wherein the electronic module 10 is cast with a liquid sealing component, in particular by means of casting resin 20, or is enclosed by a lacquer 20 or is sealed in an immersion method, preferably by means of a wax 20.

24. The method according to claim 22, wherein a shrinkage tube (21) covers the electronic module (10) with the internal body part (9) so as to provide a seal.
